(19) United States
(12) Patent Application Publication
(10) Pub. No.: US 2022/0042326 A1
(43) Pub. Date: Feb. 10, 2022

(54) MODULAR TILE ORGANIZATION SYSTEMS

(71) Applicant: Armon Jahanshahi, Portland, OR (US)

(72) Inventor: Armon Jahanshahi, Portland, OR (US)

(21) Appl. No.: 17/396,571

(22) Filed: Aug. 6, 2021

Related U.S. Application Data
(60) Provisional application No. 63/062,127, filed on Aug. 6, 2020.

(51) Int. Cl. E04F 21/00; E04F 21/22

(52) U.S. Cl. CPC E04F 21/0076; E04F 21/22

(57) ABSTRACT

Modular tile organization systems for use on a support surface. The systems include a dock and a plurality of tiles. The dock has a rear surface facing the support surface and a front surface. The dock is configured to abut the support surface with the front surface facing a user. The tiles are configured to be selectively fixed to the front surface of the dock in selected positions. The tiles include a tile body, a top, and a tile magnet. The tile body abuts the dock and defines a tile cavity. The top is disposed on the tile body, covers the tile cavity, and has a top surface. The tile magnet is disposed in the tile cavity and configured to magnetically couple the dock. The top surface is configured to be selectively marked and erased.

### CROSS REFERENCE TO RELATED APPLICATIONS

This application claims priority to U.S. Application, Ser. No. 63/062,127, filed on Aug. 6, 2020, which is hereby incorporated by reference for all purposes.

### BACKGROUND

The present disclosure relates generally to organization tools. In particular, modular tile organization systems are described.

Organization tools are useful for businesses and individuals to brainstorm new ideas, manage projects, create storyboards, and convey ideas. Various forms of organization tools exist, such as software programs (e.g., task management software, diagram creation software, etc.), dry-erase boards, bulletin boards, sticky notes, to-do lists, calendars, and Kanban boards. Organization tools may be used individually or in a group setting.

Known organization tools are not entirely satisfactory for the range of applications in which they are employed. Software based organization tools do not facilitate collaboration as physical organization tools, and they require a computing device to be on hand. Further, software-based organization tools can be overwhelming to learn and make information feel less accessible than physical organization tools.

Existing physical organization tools often undesirably rely on consumable products like paper. Consumable products are bad for the environment, create clutter, and require that supplies of the consumable be maintained.

In addition, conventional physical organization tools are often oversimplified (e.g., dry erase boards, sticky notes, etc.) or overstructured (e.g., calendars, to-do lists, etc.). Further, conventional physical organization tools tend to lack secondary features that enable more complex systems of organization, differentiation, and communication. Tools like Kanban boards are limited to a set paradigm and do not provide sufficient flexibility for the various ways that people like to develop and organize their concepts and ideas.

Conventional tile-based organization tools have a number of drawbacks. Some existing tile-based organization tools are not self-contained systems and require that users source companion components, such as dry-erase boards or large magnetically attractable surfaces. Further, known tile-based organization tools do not provide sufficient organizational aids, such as color coding or markers, to allow for more sophisticated organization schemes. Another limitation of existing tile-based organization tools is that they are limited to a certain size and are not configured to expand or retract to different sizes suitable for a given application.

Another limitation of existing tile-based organization tools is the fact that they use exposed magnets. Exposed magnets, such as sheet magnets, limit how the magnets of companion components may interact with each other, such as limiting how the components can neatly stack together. Further, exposed magnets are less aesthetically pleasing and are more prone to damage or to separating from their intended place on the components.

Thus, there exists a need for physical organization tools that improve upon and advance the design of known organization tools, which have become outdated and suboptimal. Examples of new and useful organization tools relevant to the needs existing in the field are discussed below.

Disclosure addressing one or more of the identified existing needs is provided in the detailed description below. Examples of references relevant to organization tools include U.S. Patent References: US20170018197A1, U.S. Pat. No. 9,809,049B2, US20140377736A1, US20080263917A1, and U.S. Pat. No. 10,427,450B2. The complete disclosures of these patents and patent applications are herein incorporated by reference for all purposes.

### SUMMARY

The present disclosure is directed to modular tile organization systems for use on a support surface. The systems including a dock and a plurality of tiles. The dock has a rear surface facing the support surface and a front surface. The dock is configured to abut the support surface with the front surface facing a user. The tiles are configured to be selectively fixed to the front surface of the dock in selected positions. The tiles include a tile body, a top, and a tile magnet. The tile body abuts the dock and defines a tile cavity. The top is disposed on the tile body, covers the tile cavity, and has a top surface. The tile magnet is disposed in the tile cavity and configured to magnetically couple to the dock. The top surface is configured to be selectively marked and erased.

### BRIEF DESCRIPTION OF THE DRAWINGS

FIG. 1 is a perspective view of a modular tile organization system mounted on a table surface with a plurality of tiles and buttons mounted on three adjacent docks.

FIG. 2 is a top front perspective view of the system shown in FIG. 1 in three configurations: a single dock configuration, a two dock configuration, and a three dock configuration.

FIG. 3 is an elevation view of a disassembled tile depicting magnets mounted inside a cavity of the tile near corners of the tile.

FIG. 4 is an elevation view of a disassembled button depicting a magnet mounted inside a cavity of the button.

FIG. 5 is a perspective view of a dock depicting front magnets in dashed lines mounted inside a cavity of the dock in a rectilinear grid at vertices of a rectilinear dock grid marked on the top surface of the dock.

FIG. 6A is a top plan view of a tile shown in FIG. 1.

FIG. 6B is a bottom view of the tile shown in FIG. 6A.

FIG. 6C is a side elevation view of the tile shown in FIG. 6A.

FIG. 7 is a front view of the system shown in FIG. 1 mounted vertically on a wall with tiles magnetically coupled to the dock and a first button magnetically coupled to a corner of a tile and a second button mounted to a vertex of the grid on the dock.

FIG. 8 is a schematic view depicting various arrangements of tiles in different modular tile organization system examples.

FIG. 9 is perspective view of tiles and buttons magnetically coupling to front magnets disposed in two docks in a further modular tile organization system example.

FIG. 10 is a side elevation view of a hand grasping a tile magnetically coupled to a vertical surface.

### DETAILED DESCRIPTION

The disclosed modular tile organization systems will become better understood through review of the following detailed description in conjunction with the figures. The detailed description and figures provide merely examples of the various inventions described herein. Those skilled in the art will understand that the disclosed examples may be varied, modified, and altered without departing from the scope of the inventions described herein. Many variations are contemplated for different applications and design considerations; however, for the sake of brevity, each and every contemplated variation is not individually described in the following detailed description.

Throughout the following detailed description, a variety of system examples are provided. Related features in the examples may be identical, similar, or dissimilar in different examples. For the sake of brevity, related features will not be redundantly explained in each example. Instead, the use of related feature names will cue the reader that the feature with a related feature name may be similar to the related feature in an example explained previously. Features specific to a given example will be described in that particular example. The reader should understand that a given feature need not be the same or similar to the specific portrayal of a related feature in any given figure or example.

### Definitions

The following definitions apply herein, unless otherwise indicated.

“Substantially” means to be more-or-less conforming to the particular dimension, range, shape, concept, or other aspect modified by the term, such that a feature or component need not conform exactly. For example, a “substantially cylindrical” object means that the object resembles a cylinder, but may have one or more deviations from a true cylinder.

“Comprising,” “including,” and “having” (and conjugations thereof) are used interchangeably to mean including but not necessarily limited to, and are open-ended terms not intended to exclude additional elements or method steps not expressly recited.

Terms such as “first”, “second”, and “third” are used to distinguish or identify various members of a group, or the like, and are not intended to denote a serial, chronological, or numerical limitation.

“Coupled” means connected, either permanently or releasably, whether directly or indirectly through intervening components.

### Modular Tile Organization Systems

With reference to the figures, modular tile organization systems will now be described. The systems discussed herein provide organization aids for individuals and groups. The systems enable users to display, arrange, and selectively emphasize concepts and ideas. The systems are modular and scalable to accommodate a range of needs from individual usage to group usage.

The reader will appreciate from the figures and description below that the presently disclosed systems address many of the shortcomings of conventional organization tools. For example, the systems described herein are physical tools rather than software based organization tools to better facilitate collaboration and to avoid the need for computing devices. The physical nature of the systems described below makes them engaging to use and effective for visually conveying, connecting, and interfacing with ideas.

A crucial drawback of existing tile-based organization tools is that their utility is limited to their active state, i.e., when they are in use. The modular systems described in this document address and account for the full use cycle. Further, the presently described systems provide solutions for storing all the components in a secure, contained, and visually appealing way when they are not in use. The internal arrangement of directional magnetics enables every system component to actively align by snapping into clean towers atop a dock, resulting in an organized and compact assembly when the systems are not in use

An important differentiating factor between this system and similar systems is the 3-dimensional, “object” nature of the components of the presently described systems. The components in the systems described herein are not thin, flimsy and sheet-like elements like Post-It® notes or refrigerator magnets. The system components have a tactile and mass quality more like building blocks than pieces of paper. The tactile and mass quality has an important tangible effect on user experience.

For example, the user may write several related, yet unstructured, ideas on several components and then experience the feeling of physically interacting with their previously intangible ideas, making the process of structuring ideas more interactive and accessible, which may be described as “hands-on thinking.” The sturdy magnets and voluminous objects in this system give weight and persistence to the user's ideas in contrast to flimsy sheet-like alternatives. Dedicating a physical object to an idea makes it more real and interfaceable than simply typing it in a digital app or scribbling it on a flimsy medium. The components of the systems described below encourage collaboration, interaction, and play. The three-dimensional components can be stacked and modularly arranged. Further, the three-dimensional components are designed to be aesthetic, ergonomic, and tactile objects rather than thin, cheap erasable sheets.

Improving over conventional physical organization tools, the presently described systems do not rely on consumable products like paper. By not requiring consumable products, the systems described herein are better for the environment, avoid creating clutter, and do not require that supplies of a consumable be maintained.

The systems described in this document are more robust and flexible than existing physical organization tools. Unlike oversimplified tools, like dry-erase boards and sticky notes, and overstructured tools, like to-do lists and calendars, the presently disclosed systems are sophisticated and provide multiple ways to organize, differentiate, and communicate concepts. The novel systems described herein provide secondary features that enable more complex systems of organization, differentiation, and communication. In contrast to tools like Kanban boards, the systems described herein are not limited to a set paradigm and provide ample flexibility for the various ways that people like to develop and organize their concepts and ideas.

The systems described in this document improve over conventional tile-based organization tools in a number of ways. While the presently described systems can be used with companion components if desired, they are also self-contained and avoid the need to source companion components like dry-erase boards or large magnetically attractable surfaces. Further, the systems described herein provide multiple organizational aids, including color coding and buttons, to allow for more sophisticated organization schemes. Unlike existing tile-based organization tools, the systems described in this document are not limited to a certain size and are configured to expand or retract to different sizes suitable for different applications.

Another improvement over existing tile-based organization tools is the fact that the presently disclosed system use embedded magnets rather than exposed magnets. The embedded magnets enable the components of the systems described herein to interact with each other more effectively than is possible with conventional tile-based systems with exposed magnets. For example, the components of the present system are able to neatly stack together in organized towers that would not be possible with exposed magnets. Further, the systems described in the document are more aesthetically pleasing than conventional tile-based organization systems. With embedded magnets, the magnets in the present system are less prone to damage or to separating from their intended locations.

### Contextual Details

Ancillary features relevant to the modular tile organization systems described herein will first be described to provide context and to aid the discussion of the modular tile organization systems.

### Support Surface

The modular tile organization systems described herein are configured to mount to or be supported on support surfaces. The modular tile organization systems are also typically used on support surfaces.

The support surfaces may be horizontal, vertical, or slanted surfaces. For example, horizontal support surfaces may be the top of a desk, table, counter, bench, or floor. Vertical support surfaces may be a wall, a presentation board, or a door. An angled drafting desk would be an example of a slanted support surface on which the modular tile organization systems could be supported, mounted, and/or used.

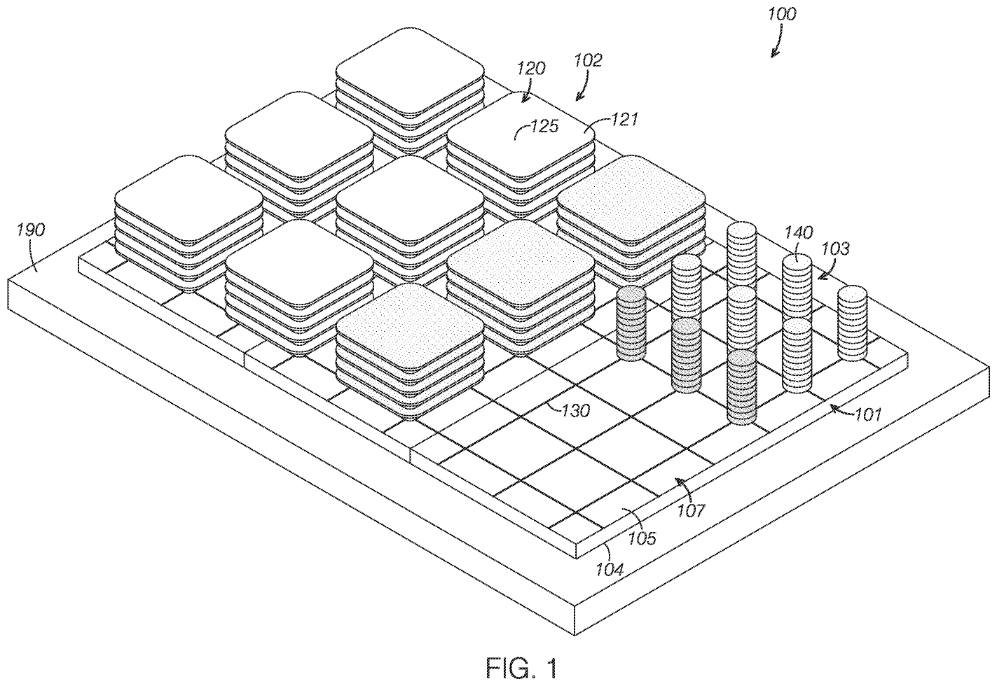

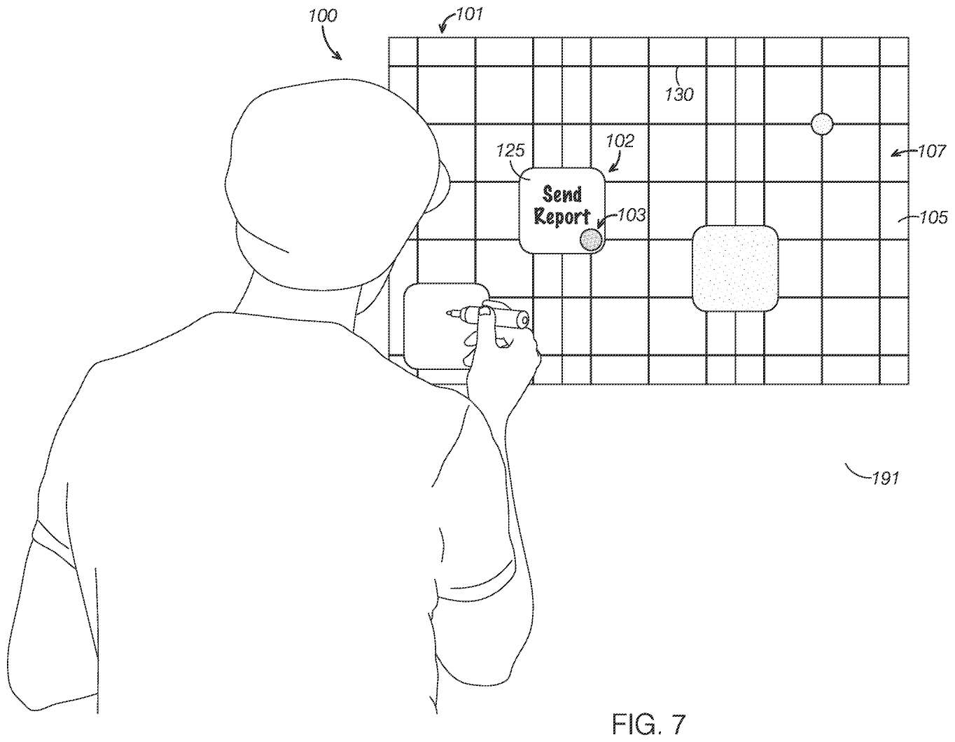

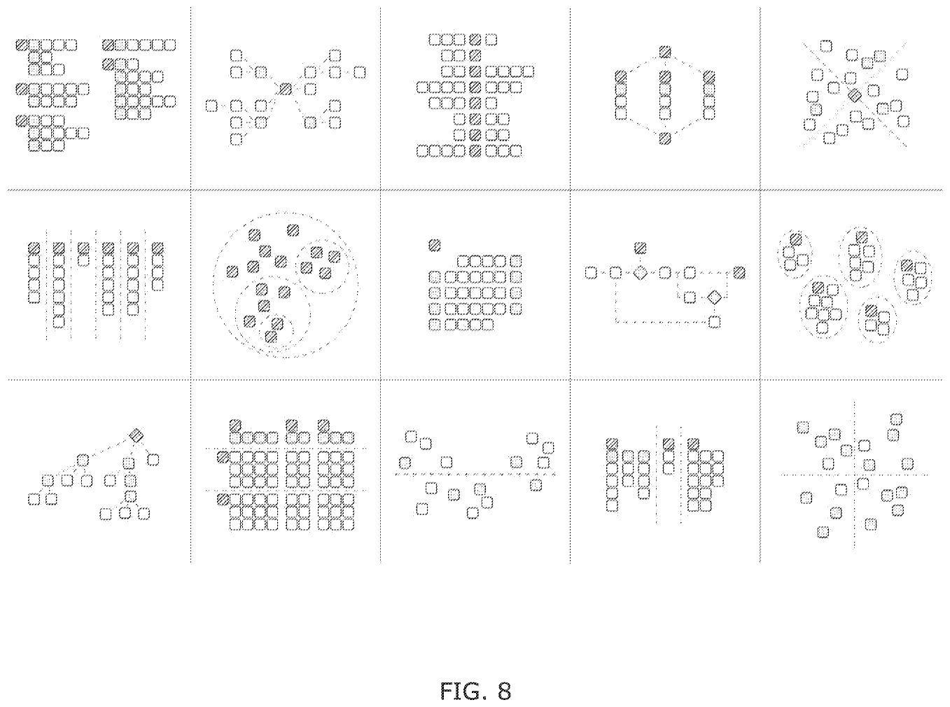

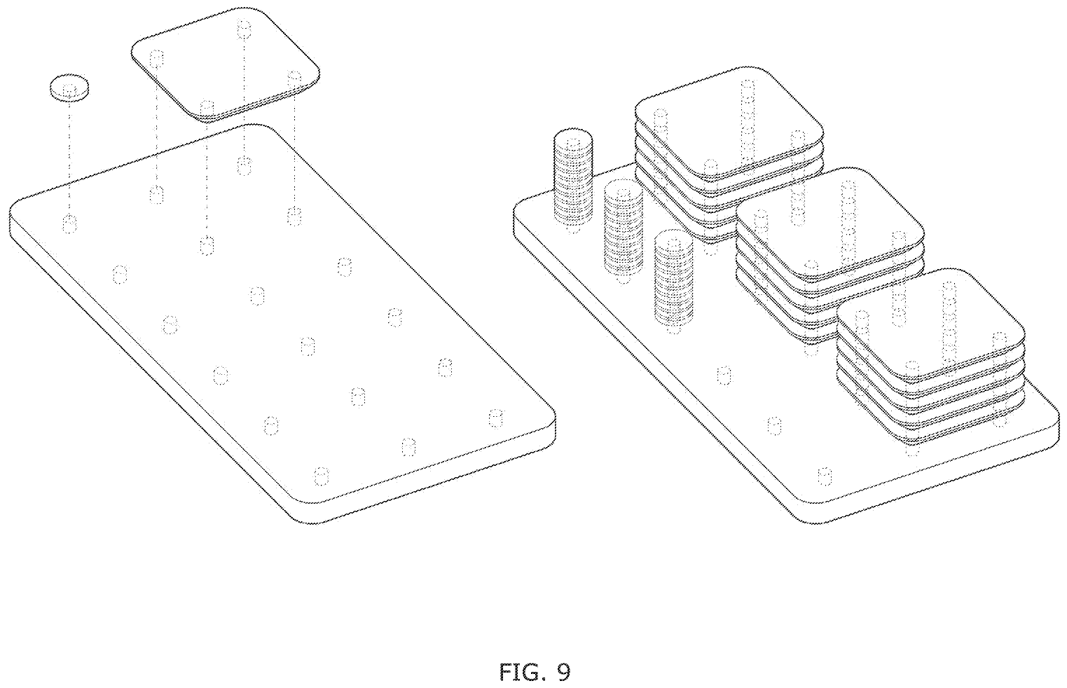

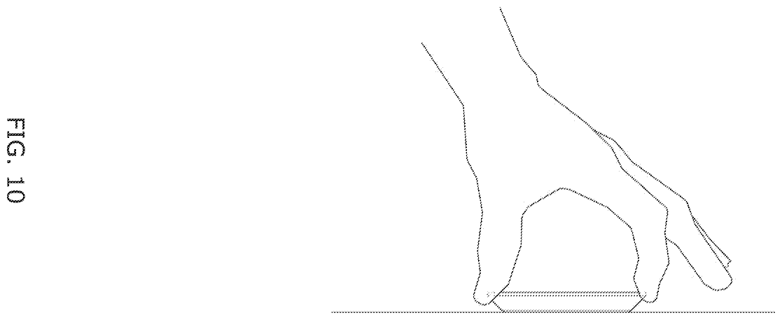

FIG. 1 depicts modular tile organization system 100 supported on a horizontal support surface 190 in the form of a table top. FIG. 7 depicts modular tile organization system 100 supported on a vertical support surface 191 in the form of a wall. The modular tile organization system is configured to enable a dock, tiles, and buttons to each magnetically couple directly to a support surface. The examples shown in FIGS. 1 and 7 depict a dock magnetically coupled to a support surface and tiles and buttons magnetically coupled to the dock; however, the tiles and buttons are configured to magnetically couple to the support surface as well. The dock is an optional feature not present in all examples of the modular tile organization system.

### Modular Tile Organization System Embodiment One

With reference to FIGS. 1-7, a first example of a modular tile organization system, modular tile organization system 100, will now be described. Modular tile organization system 100 includes a dock 101, a plurality of tiles 102, and a plurality of buttons 103.

In some examples, the modular tile organization system does not include one or more features included in system 100 depicted in FIGS. 1-7. For example, some modular tile organization system examples do not include buttons. Other examples do not include a dock. In certain examples, the system includes additional or alternative features, such as a case, marking pens, erasers, and/or adhesive note paper.

### Docks

Dock 101 functions to provide a work surface on which to organize concepts and ideas with tiles 102 and buttons 103. Dock 101 also functions to provide a magnetically attractable surface that cooperates with magnets disposed in tiles 102 and buttons 103. The dock is an optional feature not present in all examples of the modular tile organization system.

In addition or alternatively to providing a work surface, dock 101 provides a surface on which to organize the other components of system 100 when not in use. A differentiating factor between the presently described systems and other existing systems is that the present system addresses the issue of what to do with the system components between active uses, i.e., when the components are “in storage,” so to speak.

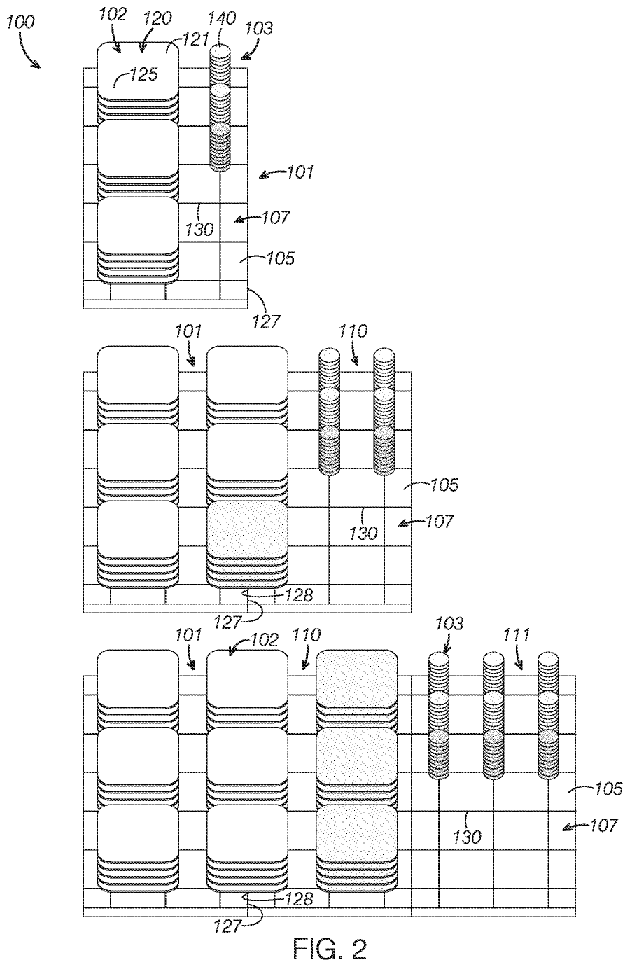

As shown in FIGS. 1 and 2, dock 101 enables all the tiles and buttons to remain organized and secure in orderly, visually satisfying tower stacks when they are not being actively used. Other systems do not consider this crucial “passive state” and just get tossed, haphazardly into some bin and are hidden from sight until they're needed again. The neat, self-aligned towers enabled by the modular systems described herein allow users to confidently leave the system out, visible, and “on hand” between uses without fear of adding clutter to the work environment.

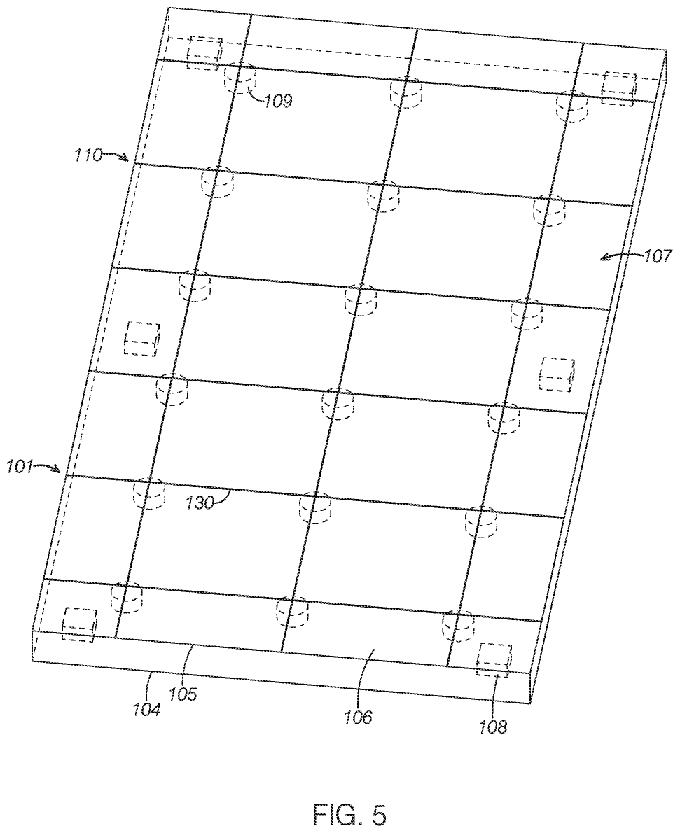

As can be seen in FIG. 7, dock 101 is wall-mountable. Dock 101 being wall mountable is another differentiator over existing organization systems. As shown in FIGS. 5 and 7, dock 101 includes mounting magnets 108 strong enough to enable the stacking system to function in any orientation. When dock 101 is wall mounted like shown in FIG. 7, system 100 has zero desktop footprint, leaving precious work-surface real estate free to host other things.

As can be seen in FIGS. 1, 2, 5, and 7, dock 101 includes a rear surface 104 and a front surface 105. Rear surface 104 faces support surface 190 or support surface 191. Front surface 105 is opposite rear surface 104.

Dock 101 is configured to abut support surface 190 or support surface 191 with rear surface 104. When rear surface 104 abuts support surface 190 or support surface 191, front surface 105 faces a user and presents the user with a work surface 107 on which to position tiles 102 and buttons 103. Work surface 107 is configured to support tiles 102 and buttons 103.

As shown in FIG. 5, dock 101 defines a dock cavity 106. Dock cavity 106 is formed between rear surface 104 and front surface 105. As shown in FIG. 5, mounting magnets 108 and front magnets 109 are disposed in dock cavity 106. In some examples, the dock cavity includes just the front magnets instead of distinct front magnets and mounting magnets.

Mounting magnets 108 are disposed in dock cavity 106 proximate rear surface 104. Mounting magnets 108 are configured to magnetically couple dock 101 to support surface 190 or support surface 191 when the support surfaces include complementary magnets or magnetically attractable materials.

Front magnets 109 are complementarily configured with tile magnets 131, 132, 133, and 134 included in tiles 102 and with button magnets 141 included in buttons 103. Further, front magnets 109 are configured to magnetically couple with tile magnets 131, 132, 133, and 134 and button magnets 141. Front magnets 109 facilitate tiles 102 and buttons 103 magnetically coupling to dock 101. In examples where the dock cavity includes just the front magnets, the front magnets function to magnetically couple with the support surface and with tile magnets and button magnets

In the example shown in FIGS. 1, 2, 5, and 7, front surface 105 includes an optional dock grid 130 printed on it. In some examples, the dock grid is etched on the front surface of the dock instead of printed on. The dock grid is not included in all examples of the dock, but may be a useful guide for placing tiles and buttons.

As shown in FIG. 5, front magnets 109 are arranged in a rectilinear grid with vertices disposed at the vertices of dock grid 130. Expressed another way, vertices of dock grid 130 on front surface 105 overlie front magnets 109. Thus, the complementary arrangement of dock grid 130 and front magnets 109 enables a user to quickly identify visually where tiles 102 and buttons 103 may be magnetically secured on dock 101.

Dock 101 may be any size and shape suitable for working with tiles 102 and buttons 103 in a given workspace. Further, as shown in FIG. 2, dock 101 is configured to be modular such that additional docks may be placed beside each other in a functionally seamless fashion to increase the size of work surface 107 and create a larger base grid. Adjacent docks may be configured to magnetically or mechanically couple to each other.

In the example shown in FIG. 2, dock 101 is adjacent to a second dock 110 in the middle of FIG. 2 to double the size of work surface 107 relative to its size with a single dock 101. As shown in FIG. 2, first lateral edge 127 of dock 101 abuts a second lateral edge 128 of second dock 110. At the bottom of FIG. 2, a third dock 111 is adjacent to second dock 110 to triple the size of work surface 107 relative to its size with a single dock 101. As shown in FIG. 2, the grids of adjacent docks are configured to align with each other to seamlessly increase the overall grid size when two docks are adjacent to each other. This modularity enables the organization system to continue to scale as needed.

With reference to FIG. 5, the reader can see that front magnets 109 of each dock are arranged such that the spacing of adjacent magnets between two adjacent docks is the same as the magnet spacing within each docket. The reader can further see in FIGS. 1-3, 5, and 7 that tile magnets embedded in tiles 102 may be complementarily aligned in a polar orientation with front magnets 109 of docks 101. The complementarily arrangement between adjacent docks and the tiles may be described as magnetic modularity.

The dock may be formed of any material currently known or later developed that is sufficiently rigid to support the tiles and the buttons and to maintain its shape. Suitable materials will also not interfere with the magnetic coupling between the tiles, the buttons, and the magnets inside the planar member. The underside of each dock module may include non-slip elements, which help keep the dock securely in place on a support surface, such as a tabletop or shelf. Keeping the dock securely in place helps create a functionally fixed system when arranging several dock modules together to create a larger dock platform, such as shown in FIG. 2.

### Tiles

The tiles function to organize ideas and concepts by displaying custom indicia in desired arrangements. The tiles also function to convey information hierarchies via readily differentiated tiles options available to users. The tile's internal magnets make the tiles moveable and positionable and enable a user to easily move them into meaningful, fixed positions relative to each other and to easily change their positions as needed. For example, it may be desirable to move a tile representing a task from an “in-progress” column on the dock to a “complete” column on the dock when the status of a task changes from in-progress to complete. The tile's internal magnets enable the tiles to readily and securely stack on top of each other as well.

As shown in FIGS. 1-3, 6A, 6B, 6C, and 7, tiles 102 include a substantially planar tile body 120 with a top 121, a bottom 122, and a tile cavity 123, which is contained within the tile and not visible to the user. Tile body 120 abuts dock 101 and defines tile cavity 123 between top 121 and bottom 122. Additionally or alternatively, the tile body of one tile may abut the tile body of another tile when the tiles are stacked and magnetically secured together. Further, the tile body may abut a button when a button is magnetically secured to the tile.

In the example shown in FIGS. 1-7, top 121 and bottom 122 are configured to secure together via a friction fit. Additionally or alternatively, an adhesive or mechanical fastener may be used to secure the top and the bottom together.

With continued reference to FIGS. 1-3, 6A, 6B, 6C, and 7, top 121 includes a top surface 125 and bottom 122 includes a bottom surface 126. Top surface 125 is flat and substantially parallel to the front surface 105 of dock 101.

While the tiles depicted in the figures are substantially planar, some examples include one or more tiles with substantial dimensions in all three axes. Expressed another way, the tiles may be more three-dimensional than the substantially planar examples depicted in the figures.

As can be seen in FIGS. 1-3, 6A, 6B, 6C, and 7, tile 102 is substantially square with rounded corners. However, the tiles may be any desired shape, such as triangular, rectangular, circular, oval, other regular polygons, or an irregular shape. In some examples, different tiles have different shapes, such as a mix of square, rectangular, and circular tiles. The tiles may be formed from any currently known or later developed material suitable for organization tools, including plastics, metals, wood, and composites materials.

As shown in FIG. 7, tile 102 is coated with a markable and eraseable coating to enable a user to write and erase ideas and concepts onto top surface 125. In some examples, the writable surface is integral to the material used to form the tile, i.e., a separate coating is not applied and the tile material itself accommodates writing and erasing. The coating or tile material may be similar to a dry-erase board surface to enable a user to readily erase prior markings. The coating or tile material may be any currently known or later developed coating or material enabling users to write on the tiles and erase the markings as desired.

In some examples, just the top surface is writable. In other examples, the entire tile is configured to be written on. In examples where the tile is coated with a writeable coating, the entire tile may be coated or just the top surface may be coated.

In the example shown in FIG. 1 and in other figures, tiles 102 include differentiating features to enable organizing them into readily differentiated groups. As shown in FIG. 1, the differentiating feature is color; that is, tiles in one group are a first color and tiles in another group are a separate color. In other examples, the differentiating feature may be shape, texture, pattern, size, fixed indicia, or other differentiators.

The readily differentiated groups enable organization based on the different groupings, such as hierarchies. In the example shown in FIGS. 1 and 2, tiles 102 are organized into a primary group and a secondary group. The tiles may be formed into tertiary groups or more groupings as well. The number of groups may be selected to suit a given application, such a single group, two groups as depicted in FIGS. 1 and 2, three groups, four groups, or more than four groups.

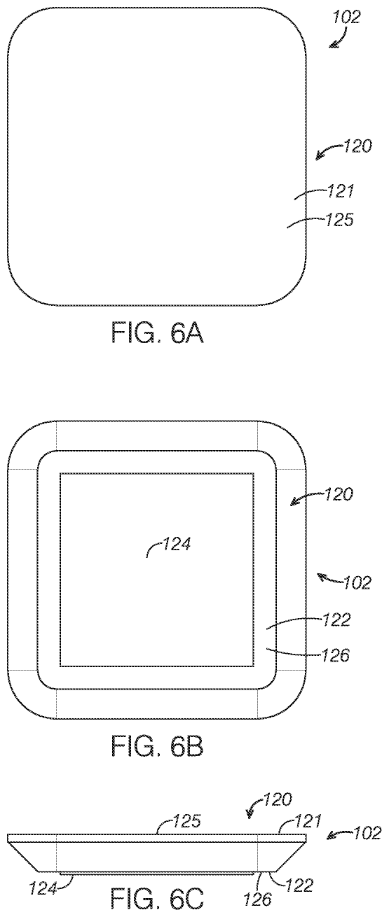

As shown in FIGS. 6A and 6B, tile 102 includes a non-slip material 124 applied to a bottom surface 126 of bottom 122. Non-slip material 124 may be applied in any currently known or later developed manner, such as via adhesives or mechanical fasteners. Any currently known or later developed non-slip material may be used.

In the example shown in FIGS. 6B and 6C, non-slip surface 124 is in the shape of a continuous flat sheet. The non-slip surface may be in the shape of a ring or frame among many other shapes. A sheet of non-slip material may be desirable when more resistance to sliding is preferred.

A ring of non-slip material may be desirable in circumstances where less non-slip material is desired, such as for cost or slide allowance purposes. Additionally or alternatively, the ring of non-slip material may be desired when seeking to preserve indicia printed on a tile when stacking the tiles. Providing a ring of non-slip material about the perimeter of a tile, as opposed to a sheet of non-slip material, serves the important purpose of reducing the likelihood of smudging the indicia on the tile below a given tile when stacking the tiles. The ring of non-slip material provides friction on the perimeter of the tile while leaving the middle of the tile contact-free.

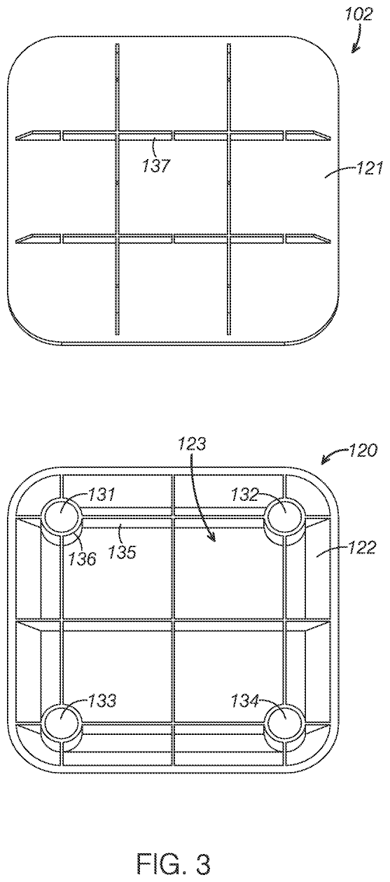

As shown in FIG. 3, tile 102 includes four tile magnets: a first tile magnet 131, a second tile magnet 132, a third tile magnet 133, and a fourth tile magnet 134. First tile magnet 131, second tile magnet 132, third tile magnet 133, and fourth tile magnet 134 are configured to magnetically couple to front magnets 109. Additionally or alternatively, first tile magnet 131, second tile magnet 132, third tile magnet 133, and fourth tile magnet 134 are configured to magnetically couple to corresponding tile magnets in another tile and enable the tiles to stack together. Further, first tile magnet 131, second tile magnet 132, third tile magnet 133, and fourth tile magnet 134 are configured to magnetically couple to button magnet 141 and enable button 103 to secure to tile 102 in a position overlying one of the tile magnets. As shown in FIG. 3, the tile magnets are secured to the bottom portion of tile 102 within tile cavity 123.

The number of tile magnets may vary from one to a plurality of magnets to suit different applications. The tile magnets may be any currently known or later developed type of magnet and may be any suitable size and shape.

In the example shown in FIG. 3, the tile magnets are disposed proximate the corners of tile 102 within tile cavity 123, but other arrangements of the magnets are contemplated. For example, the tile magnets may be more centrally located and/or may be located closer to the middle of each edge instead of the corners. However, the arrangement depicted in FIG. 3 is effective to cooperate with the rectilinear dock grid 130 and arrangement of front magnets 109 in dock 101 to position tiles 102 in an organized, rectilinear fashion on dock 101. The collective position and alignment of the tile magnets and front magnets enables tile 102 to automatically align to dock grid 130 when one or more of the first tile magnet 131, second tile magnet 132, third tile magnet 133, and fourth tile magnet 134 aligns with the front magnets 109.

The reader can see in FIG. 3 that tiles 102 include bottom ribs 135 for strength and rigidity within tile cavity 123. As shown in FIG. 3, bottom ribs 135 define mounting points 136 for the tile magnets to secure. The top portion of tile 102 includes top ribs 137 that are complementarily configured with bottom ribs 135 to be aligned when tile 102 is fully assembled. In some examples, the top portion of the tile does not include top ribs. The top portion of the tile may be secured to the bottom portion of the tile with adhesives, a friction fit, or mechanical fasteners.

In some examples, the tiles include identifiers to assist with tracking the positions of the tiles relative to each other, relative to buttons, and/or relative to the dock. The buttons and docks may also include identifiers.

The identifiers may comprise RFID tags embedded in the tiles. Additionally or alternatively, the identifiers may include crosshair indicia, barcodes, or QR codes displayed on their front and/or back facing surfaces. The reader will appreciate that tracking the tiles with the identifiers may be accomplished manually or digitally using a smart phone or machine vision system.

### Buttons

Buttons 103 function to highlight and differentiate selected tiles. Additionally or alternatively, buttons 103 serve to independently convey concepts and ideas, such as units of time between tiles in a timeline, priority between tiles in a list, and assignment of tiles to high-level categories or teams.

In the example shown in FIGS. 1-7, buttons 103 include a button body 140 and a button magnet 141. In other examples, the button includes additional or alternative features.

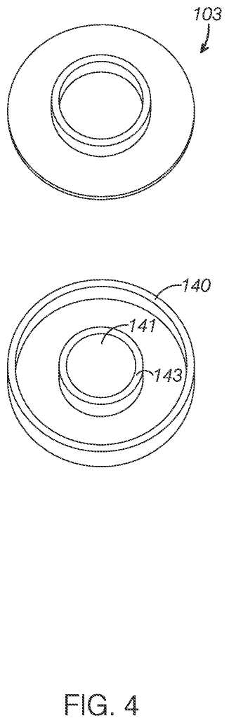

As shown in FIG. 4, button body 140 forms a circular disk. However, the button bodies of the buttons may be any shape or combination of shapes. For example, one or more of the buttons could be round, oval, square, rectangular, triangular, another regular polygon, or an irregular shape. The thickness of the buttons may range between dimensions yielding substantially planar buttons to substantially three-dimensional buttons. The body of the button may be formed from any currently known or later developed material, such as plastics, metals, wood, and composite materials.

As shown in FIGS. 1, 2 and 7, buttons 103 are smaller than tiles 102. As shown in FIG. 7, the smaller size of buttons 103 enables them to magnetically couple to tiles 102 while obscuring only a relatively small portion of top surface 125 of tile 102. By obscuring a relatively small area of top surface 125, buttons 103 avoid obscuring information written on top surface 125 of tile 103.

As shown in FIG. 4, button magnet 141 is secured in a recess 143 formed inside button body 140. In other examples, the magnet is secured to the bottom, external surface of the body of the button. The magnet may be any currently known or later developed type of magnet suitable for organization tool applications.

As shown in FIG. 4, recess 143 secures button magnet 141 in a central location of button body 140. However, the magnet could be secured to the body in any desired location beyond central locations.

In the example shown in the figures, such as depicted in FIG. 7, buttons 103 and tiles 102 cooperate to magnetically couple buttons 103 to tiles 102 proximate the corners of tiles 102. In particular, button 103 is configured to magnetically couple to the tile magnets disposed in the corners of tile 102. As shown in FIG. 7, magnetically coupling buttons 103 to the corners of tile 102 helps maintain a large, central, unobstructed area for writing on tiles 102.

Further, button 103 is configured to be selectively fixed to front surface 105 of dock 101 in a selected position. In particular, button 103 is configured to magnetically couple with front magnets 109 of dock 101.

The buttons are also configured to magnetically secure to each other in stacked configurations, such as towers. Stacking buttons may be used to convey priority levels, units of time, monetary value, and a wide variety of other concepts. For example, a tile with one button secured to it may denote a low priority tile whereas a tile with two buttons stacked on top of each other may denote a higher priority tile.

As shown in FIG. 7, button 103 and tile 102 magnetically couple to each other securely when tile 102 is vertically oriented. Further, button 103 and tile 102 magnetically couple to each other and to dock 101 securely when dock 101 is oriented vertically. Buttons 103 also securely couple to each other magnetically when extending from a vertically oriented surface, such as a wall, a tile, or a dock. The secure magnetic coupling of tiles 102, buttons 103, and dock 101 enables system 100 to be used effectively in any orientation.

In the example shown in FIGS. 1, 2 and 7, the plurality of buttons includes readily differentiated groups of buttons to enable organization based on the different groupings, such as hierarchies. In the present example, buttons 103 are differentiated into two distinct groups based on color. The number of button groups may be selected to suit a given application, such a single group, two groups, three groups, four groups, or more than four groups.

As shown in FIGS. 1, 2, and 7, buttons 103 are a different shape than tiles 102. In particular, buttons 103 are round whereas tiles 102 are substantially square. However, the buttons may be any shape, including square, suitable for a given application.

As can further be seen in FIGS. 1, 2, and 7, buttons 103 are a different size than tiles 102. In the example shown in FIGS. 1-7, buttons 103 are smaller than tiles 102. However, the buttons may be any size, larger, smaller, or the same size, as the tile.

As shown in FIGS. 1, 2, and 7, system 100 includes a plurality of buttons 103. However, the system may include any given number of buttons. In some examples, the system does not include buttons. In certain examples, the system includes more or fewer buttons than depicted in the figures.

Like the tiles, the buttons may be marked on and erased. Button 103 is coated with a markable and eraseable coating to enable a user to write and erase ideas and concepts onto button body 140. In some examples, the writable surface is integral to the material used to form the button, i.e., a separate coating is not applied and the button material itself accommodates writing and erasing. The coating or button material may be similar to a dry-erase board surface to enable a user to readily erase prior markings. The coating or button material may be any currently known or later developed coating or material enabling users to write on the buttons and erase the markings as desired.

In some examples, just the top surface of the button is writable. In other examples, the entire button is configured to be written on. In examples where the button is coated with a writeable coating, the entire button may be coated or just the top surface of the button may be coated.

### Additional Embodiments

The systems described above may be arranged and/or modified into various different configurations. For example, the systems may be arranged in various vertical configurations and horizontal configurations. In some examples, the systems are configured at an angle between vertical and horizontal, such as when positioned on a tilted drafting table.

The disclosure above encompasses multiple distinct inventions with independent utility. While each of these inventions has been disclosed in a particular form, the specific embodiments disclosed and illustrated above are not to be considered in a limiting sense as numerous variations are possible. The subject matter of the inventions includes all novel and non-obvious combinations and subcombinations of the various elements, features, functions and/or properties disclosed above and inherent to those skilled in the art pertaining to such inventions. Where the disclosure or subsequently filed claims recite “a” element, “a first” element, or any such equivalent term, the disclosure or claims should be understood to incorporate one or more such elements, neither requiring nor excluding two or more such elements.

Applicant(s) reserves the right to submit claims directed to combinations and subcombinations of the disclosed inventions that are believed to be novel and non-obvious. Inventions embodied in other combinations and subcombinations of features, functions, elements and/or properties may be claimed through amendment of those claims or presentation of new claims in the present application or in a related application. Such amended or new claims, whether they are directed to the same invention or a different invention and whether they are different, broader, narrower or equal in scope to the original claims, are to be considered within the subject matter of the inventions described herein.

1. A modular tile organization system for use on a support surface, comprising:
a dock having a rear surface facing the support surface and a front surface opposite the rear surface, the dock being configured to abut the support surface with the front surface facing a user and defining a dock cavity between the rear surface and the front surface; and
a plurality of tiles configured to be selectively fixed to the front surface of the dock in a selected position;
wherein the plurality of tiles includes a first tile;
wherein the first tile includes:
a tile body abutting the dock and defining a tile cavity;
a top disposed on the tile body, covering the tile cavity, and having a top surface facing away from the tile body; and
a first tile magnet disposed in the tile cavity;
wherein the first tile magnet is configured to magnetically couple the first tile to the dock; and
wherein the top surface of the first tile is configured to be selectively marked and erased.

2. The system of claim 1, wherein the plurality of tiles includes a second tile configured the same as the first tile except being a different color than the first tile.

3. The system of claim 1, wherein the top surface is flat and substantially parallel to the front surface of the dock.

4. The system of claim 1, wherein:
the dock defines a first dock;
the modular tile organization system further comprises a second dock;
the second dock is configured the same as the first dock;
the first dock includes a first lateral edge;
the second dock includes a second lateral edge facing the first lateral edge; and
the second dock is selectively adjacent to the first dock with the first lateral edge abutting the second lateral edge.

5. The system of claim 4, wherein:
the first dock includes a first grid disposed on the front surface of the first dock;
the second dock includes a second grid disposed on the front surface of the second dock;
the first grid and the second grid are aligned to define a continuous grid when the first dock is selectively adjacent to the second dock with the first lateral edge abutting the second lateral edge.

6. The system of claim 1, wherein the dock includes a mounting magnet disposed in the dock cavity proximate the rear surface and configured to magnetically couple the dock to the support surface.

7. The system of claim 1, wherein the dock includes a plurality of front magnets disposed in the dock cavity proximate the front surface and configured to magnetically couple to the tile magnet.

8. The system of claim 7, wherein the front magnets are arranged in a rectilinear grid with vertices and the front magnets are disposed at the vertices of the rectilinear grid.

9. The system of claim 8, wherein the dock includes a dock grid with dock grid vertices disposed on the front surface aligned with the rectilinear grid arrangement of front magnets.

10. The system of claim 9, wherein the dock grid vertices on the front surface overlie the front magnets.

11. The system of claim 10, wherein:
the first tile further includes:
a second tile magnet;
a third tile magnet; and
a fourth tile magnet;
the first tile magnet, the second tile magnet, the third tile magnet, and the fourth tile magnet are configured to magnetically couple to the front magnets.

12. The system of claim 11, wherein:
the first tile has a square profile defining four corners; and
the first tile magnet, the second tile magnet, the third tile magnet, and the fourth tile magnet are disposed in the tile body proximate the corners of the square profile.

13. The system of claim 12, wherein the first tile automatically aligns to the dock grid disposed on the front surface of the dock when one or more of the first tile magnet, the second tile magnet, the third tile magnet, and the fourth tile magnet aligns with the front magnets.

14. The system of claim 1, wherein the front surface of the dock is configured to be selectively marked and erased.

15. The system of claim 1, further comprising a button configured to be selectively fixed to the front surface of the dock in a selected position, the button including:
a button body; and
a button magnet disposed within the button body.

16. The system of claim 15, wherein the button is further configured to magnetically couple to the first tile magnet.

17. The system of claim 16, wherein the button and the first tile magnetically couple to each other or to the dock securely when the dock is oriented vertically.

18. The system of claim 15, wherein the button is a different shape than the first tile.

19. The system of claim 15, wherein the button is a different size than the first tile.

20. The system of claim 15, wherein:
the modular tile organization system includes a plurality of buttons configured substantially the same as the button; and
the button is one of the plurality of buttons.
